(19) United States
(12) Patent Application Publication
(10) Pub. No.: US 2023/0186219 A1
(43) Pub. Date: Jun. 15, 2023

(54) SYSTEM AND METHOD FOR ENTERPRISE CHANGE MANAGEMENT EVALUATION

(71) Applicants: Kevin M. Savage, Glastonbury, CT (US); Matthew R. Boilard, Bristol, CT (US); Darrell Phillip Carrow, Houston, TX (US); Andrea S. Drake, Middletown, CT (US); Julie Ann Marie Schell, Granite Bay, CA (US)

(72) Inventors: Kevin M. Savage, Glastonbury, CT (US); Matthew R. Boilard, Bristol, CT (US); Darrell Phillip Carrow, Houston, TX (US); Andrea S. Drake, Middletown, CT (US); Julie Ann Marie Schell, Granite Bay, CA (US)

(21) Appl. No.: 17/644,240

(22) Filed: Dec. 14, 2021

(51) Int. Cl. G06Q 10/06

(52) U.S. Cl. CPC G06Q 10/0639

(57) ABSTRACT

A change management evaluation system may be implemented via a back-end application computer server. An enterprise health data store contains electronic records associated with a set of enterprise units. Each electronic record includes an electronic record identifier and health dimension scores associated with an enterprise’s ability to implement changes. Moreover, one health dimension score is based at least in part on a sentiment score automatically generated by a machine learning algorithm analysis of unstructured text data. The computer server may then automatically retrieve, from the enterprise health data store, the health dimension scores associated with each enterprise unit. A weighted average model may be used to automatically calculate an overall unit health score for each enterprise unit based on the associated health dimension scores. A change management scorecard of an interactive graphical change management display is then updated and displayed based on the overall unit health scores.

### TECHNICAL FIELD

The present application generally relates to computer systems and more particularly to computer systems that are adapted to accurately and/or automatically evaluate change management for an enterprise.

### BACKGROUND

An enterprise may be interested in understanding how prepared various units within the enterprise are to implementing changes. For example, would implementing a significant new business process cause major technological or staff issues? Will it force leaders and/or employees to learn new skills or require significant adaptations? Being able to implement changes in an efficient and flexible manner can help an enterprise grow and remain competitive.

Consider, for example, a merger or acquisition. The technical side of the change can be complex and involve the financial arrangements of the deal, the integration business systems, decisions about the new organization’s structure, etc. Moreover, getting employees on board and participating in the merger or acquisition can influence the result of the change. As used herein, the phrase “change management” may refer to the application of a structured process and set of tools for leading a change to achieve a desired outcome. A change management process may let practitioners within an enterprise leverage and scale change management activities that help impacted individuals and groups move through transitions. At the organizational level, change management may involve leadership competency for enabling change within the enterprise and represent a strategic capability designed to increase change capacity and responsiveness.

A manual, subjective evaluation of the enterprise’s change management ability (e.g., performed by a manager) can be a time consuming and error-prone process. Moreover, subjective evaluations and/or different opinions about the importance of various aspects of change management could lead to different results between enterprise units and/or over a period of time (e.g., from year to year when a manager is replaced).

It would therefore be desirable to provide improved systems and methods to accurately and/or automatically perform change management evaluation for an enterprise. Moreover, the results should be easy to access, understand, interpret, update, etc.

### SUMMARY OF THE INVENTION

According to some embodiments, systems, methods, apparatus, computer program code and means are provided to accurately and/or automatically perform change management evaluation for an enterprise in a way that provides fast and useful results and that allows for flexibility and effectiveness when responding to those results.

Some embodiments are directed to a change management evaluation system implemented via a back-end application computer server. An enterprise health data store contains electronic records associated with a set of enterprise units. Each electronic record includes an electronic record identifier and plurality of health dimension scores associated with an enterprise’s ability to implement changes. Moreover, at least one health dimension score is based at least in part on a sentiment score automatically generated by a machine learning algorithm analysis of unstructured text data. The computer server may then automatically retrieve, from the enterprise health data store, the health dimension scores associated with each enterprise unit. A weighted average model may be used to automatically calculate an overall unit health score for each enterprise unit based on the associated health dimension scores. A change management scorecard of an interactive graphical change management display is then updated and displayed based on the overall unit health scores.

Some embodiments comprise: means for automatically retrieving, by a computer processor of a back-end application computer server from an enterprise health data store, health dimension scores associated with each of a set of enterprise units, wherein the enterprise health data store contains electronic records associated with the set of enterprise units, each electronic record including an electronic record identifier and plurality of health dimension scores associated with an enterprise’s ability to implement changes, wherein at least one health dimension score is based at least in part on a sentiment score automatically generated by a machine learning algorithm analysis of unstructured text data; for each enterprise unit, means for using a weighted average model to automatically calculate an overall unit health score for each enterprise unit based on the associated health dimension scores; and means for updating a change management scorecard of an interactive graphical change management display based on the calculated overall unit health scores. Note that a communication port coupled to the back-end application computer server may facilitate an exchange of data with a remote change management device to support the interactive graphical change management display (including the updated change management scorecard) via a distributed communication network.

In some embodiments, a communication device associated with a back-end application computer server exchanges information with remote devices in connection with an interactive graphical change management interface. The information may be exchanged, for example, via public and/or proprietary communication networks.

A technical effect of some embodiments of the invention is an improved and computerized way to accurately and/or automatically perform change management evaluation for an enterprise in a way that provides fast and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 illustrates one possible enterprise structure.

FIG. 2 is a high-level block diagram of a change management evaluation system in accordance with some embodiments.

FIG. 3 illustrates a change management evaluation method according to some embodiments of the present invention.

FIG. 4 is an example of a change management scorecard in accordance with some embodiments.

FIG. 5 is a scorecard including information about prior overall unit health scores according to some embodiments.

FIG. 6 illustrates an interactive popup display in accordance with some embodiments.

FIG. 7 is an example of health dimension score components according to some embodiments.

FIG. 8 is a spreadsheet application to calculate weights in accordance with some embodiments.

FIG. 9 is a spreadsheet application change management worksheet according to some embodiments.

FIG. 10 is a block diagram of an apparatus in accordance with some embodiments of the present invention.

FIG. 11 is a portion of an enterprise health data store according to some embodiments.

FIG. 12 illustrates an administrator display in accordance with some embodiments.

FIG. 13 illustrates a smartphone display according to some embodiments.

FIG. 14 illustrates a handheld tablet display in accordance with some embodiments.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data availability, consistency, and analytics associated with a change management evaluation system. The present invention is directed to more than merely a computer implementation of a routine or conventional activity previously known in the industry as it provides a specific advancement in the area of electronic record availability, consistency, and analysis by providing improvements in the operation of a computer system that uses machine learning and a weighted average model to implement a change management evaluation. The present invention provides improvement beyond a mere generic computer implementation as it involves the novel ordered combination of system elements and processes to provide improvements in the speed at which such data can be made available and consistent results. Some embodiments of the present invention are directed to a system adapted to automatically determine change management information, analyze electronic records, aggregate data from multiple sources including text mining, determine appropriate scores and responses, etc. Moreover, communication links and messages may be automatically established, aggregated, formatted, exchanged, etc. to improve network performance (e.g., by reducing an amount of network messaging bandwidth and/or storage required to support change management evaluation, implement technological updates, etc.).

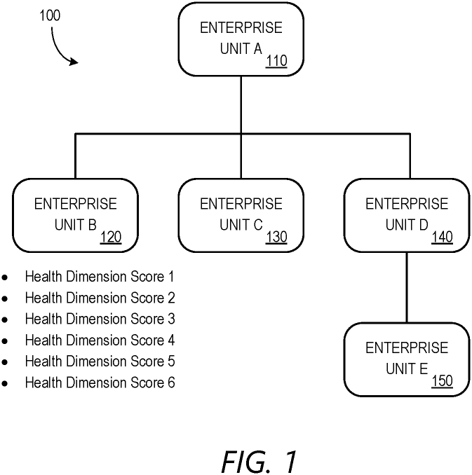

According to some embodiments, an enterprise may be evaluated unit-by-unit. For example, FIG. 1 illustrates one possible enterprise structure 100. The structure 100 represents a hierarchy of enterprise units 110, 120, 130, 140, 150 (units A through E). Although five units are illustrated in FIG. 1, any number of business sub-entities, departments, lines of business, etc. may be involved and might be arranged in any format. Each enterprise unit may be evaluated for change management using a number of different health dimension scores (e.g., scores 1 through 6 for enterprise unit B 120 as illustrated in FIG. 1). Note that any number of health dimension scores may be implemented according to various embodiments.

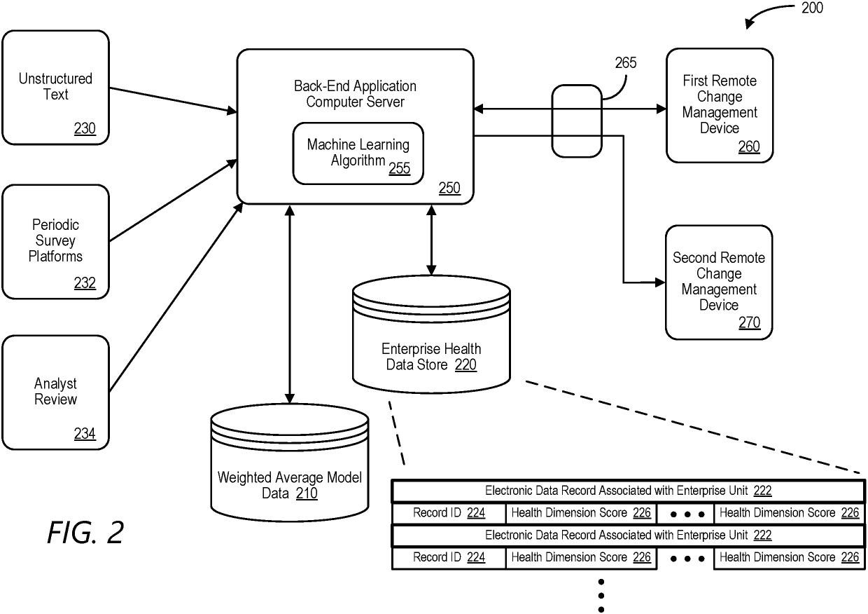

Evaluation of the structure 100 may then be automatically performed. FIG. 2 is a high-level block diagram of a change management evaluation system 200 according to some embodiments of the present invention. In particular, the system 200 includes a back-end application computer server 250 that may access a weighted average model 210 and information in an enterprise health data store 220 (e.g., storing a set of electronic records associated with enterprise units 222, each record including, for example, one or more record identifiers 224, health dimension scores 226, etc.). The back-end application computer server 250 may also store information into other data stores and utilize a Graphical User Interface (“GUI”) and machine learning algorithm 255 to view, analyze, and/or update the electronic records. The back-end application computer server 250 may also exchange information with remote change management devices 260, 270 (e.g., via a firewall 265). According to some embodiments, unstructured text 230 (e.g., from periodic employee satisfaction survey comments), data from periodic survey platforms 232 (e.g., automatically collected by the back-end application computer server 250 via communication links), and/or analyst review information 234 (e.g., a subjective peer or team review of insights and analysis that results in a consensus view) may be aggregated, analyzed, and provided to the remote change management devices 260, 270. In some embodiments, the first remote change management device 260 may transmit annotated and/or updated information to the back-end application computer server 250. Based on the updated information, the back-end application computer server 250 may adjust data in the enterprise health data store 220 and/or the change may be viewable via the second remote change management device 270. Note that the back-end application computer server 250 and/or any of the other devices and methods described herein might be associated with a third party, such as a vendor that performs a service for an enterprise.

The back-end application computer server 250 and/or the other elements of the system 200 might be, for example, associated with a Personal Computer (“PC”), laptop computer, smartphone, an enterprise server, a server farm, and/or a database or similar storage devices. According to some embodiments, an “automated” back-end application computer server 250 (and/or other elements of the system 200) may facilitate the automated access and/or update of electronic records. As used herein, the term “automated” may refer to, for example, actions that can be performed with little (or no) intervention by a human.

As used herein, devices, including those associated with the back-end application computer server 250 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 250 may store information into and/or retrieve information from the enterprise health data store 220. The data store 220 may be locally stored or reside remote from the back-end application computer server 250. As will be described further below, the enterprise health data store 220 may be used by the back-end application computer server 250 in connection with a change management evaluation. Although a single back-end application computer server 250 is shown in FIG. 2, any number of such devices may be included. Moreover, various devices described herein might be combined according to embodiments of the present invention. For example, in some embodiments, the back-end application computer server 250 and the enterprise health data store 220 might be co-located and/or may comprise a single apparatus and/or be implemented via a cloud-based computing environment.

In this way, embodiments may provide an innovative approach for assessing how large-scale, strategic programs implementing business process and technology changes impact operations in an enterprise. A change management scorecard may use a combination of factors and algorithms to create an indication of change management health for various units of a business. This indication may serve as a signal for understanding how changes are received and acted upon by leaders and front-line employees. The scorecard may inform managers and senior leaders help decision-making and address operational risks, such as change saturation, employee fatigue or burnout, workloads, etc.

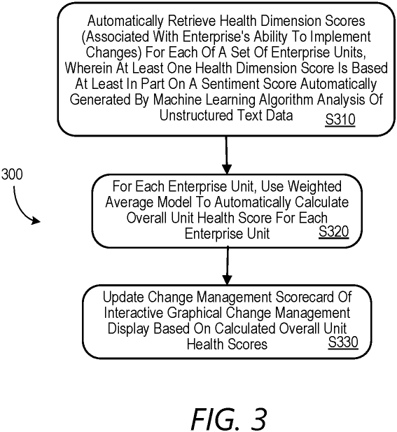

Note that the system 200 of FIG. 2 is provided only as an example, and embodiments may be associated with additional elements or components. FIG. 3 illustrates a method 300 that might be performed by some or all of the elements of the system 200 described with respect to FIG. 2, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, a computer processor of the back-end application computer server may retrieve (from an enterprise health data store) health dimension scores associated with each of a set of enterprise units. The enterprise health data store may, according to some embodiments, contain electronic records associated with the set of enterprise units. Each electronic record may include, for example, an electronic record identifier and plurality of health dimension scores associated with an enterprise’s ability to implement changes. Moreover, at least one health dimension score may be based at least in part on a sentiment score automatically generated by a machine learning algorithm analysis of unstructured text data. As used herein, the phrase “machine learning” may refer to an algorithm that improves automatically through experience and the use of data. A machine learning algorithm (or predictive analytic) may build a model based on sample data (e.g., training data) to make a prediction and/or decision without the use of explicit programming. According to some embodiments, the machine learning algorithm may use data and one or more neural networks.

Note that the health dimension scores may include subjective scores, objective scores, qualitative scores, quantitative scores, etc. According to some embodiments, at least one health dimension score is associated with: a numerical rating (e.g., a score from 1 to 10); a category (e.g., high, medium, or low); a percentage (e.g., indicating how many employees agreed with a statement); a periodic survey (e.g., quarterly or monthly); a change consultant or peer review analysis, etc. Examples of health dimension scores might include: initiatives impact (e.g., technology impact, process impact, or skill impact); employee satisfaction (e.g., attrition, work enjoyment data); leader change readiness (e.g., ability to adapt); employee change readiness (e.g., ability to navigate change); leader engagement (e.g., based on interactions); employee sentiment (e.g., survey comments, feedback trends, and automated text mining), etc.

For each enterprise unit, at S320 the system uses a weighted average model to automatically calculate an overall unit health score for each enterprise unit based on the associated health dimension scores. According to some embodiments, weights for the weighted average model are automatically calculated based on a plurality of weight scores. Moreover, an overall enterprise health score may then be calculated based on the overall unit health score for each enterprise unit.

At S330, the system may update a change management scorecard of an interactive graphical change management display based on the calculated overall unit health scores. According to some embodiments, selection of an enterprise unit on the change management scorecard results in the display of the associated health dimension scores for that enterprise unit on the interactive graphical change management display. Moreover, the change management scorecard might include both: (1) current overall unit health scores, and (2) information about prior overall unit health scores (e.g., to highlight and understand trending over time).

According to some embodiments, a communication port coupled to the back-end application computer server facilitates an exchange of data with a remote change management device to support the interactive graphical change management display (including the updated change management scorecard) via a distributed communication network. In some embodiments, the enterprise comprises an insurance company and the enterprise units are associated with insurance Lines Of Business (“LOB”), such as automobile, property, group benefits, workers’ compensation, general liability, etc.

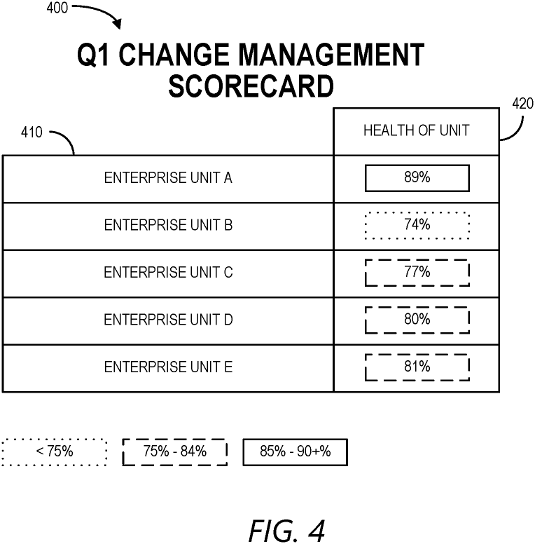

FIG. 4 is an example of a change management scorecard 400 showing data associated with a first quarter (“Q1”) in accordance with some embodiments. The scorecard 400 includes health scores 420 for various enterprise units 410 (e.g., units A through E). Moreover, the health scores 420 might be color coded or use border types to identify different health categories (e.g., dotted lines for scores under 75%, dashed lines for scores from 75% to 84%, and solid lines for scores 85% or higher). According to some embodiments, a user can annotate information on the scorecard (e.g., to explain an unusual health score 420, interpret change management results, etc.).

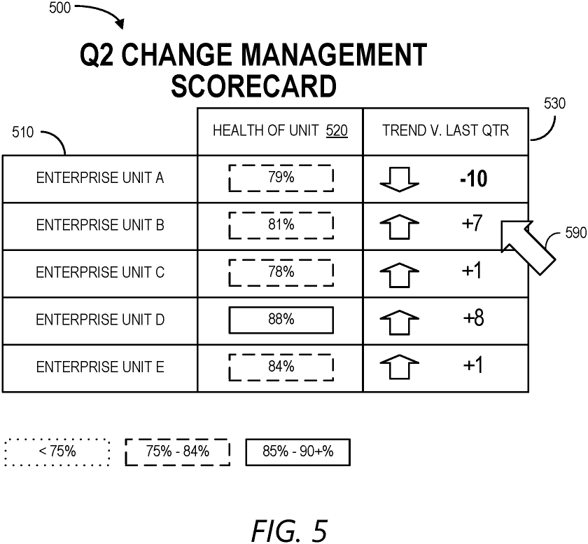

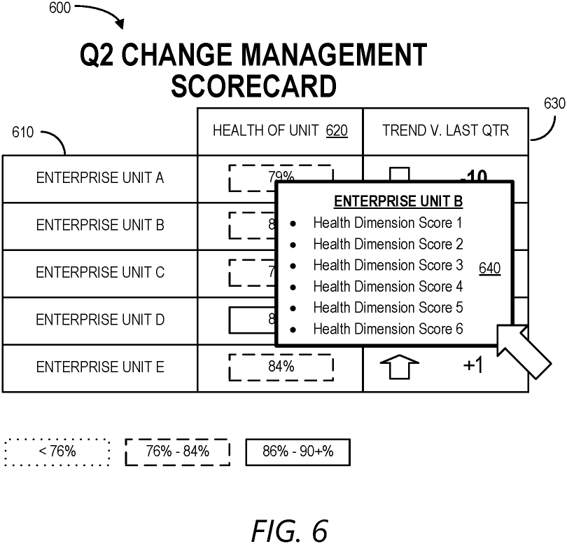

FIG. 5 is a scorecard 500 that includes information about prior overall unit health scores according to some embodiments. In particular, the scorecard 500 includes, for various enterprise units 510, health scores 520 for a second quarter (“Q2”). The scorecard 500 also includes a comparison 530 of the Q2 health scores 520 with those from Q1 (e.g., as shown in FIG. 4). Selection of a row in the scorecard 500 (e.g., via touchscreen or computer mouse pointer 590) may result in the display of further information about that particular enterprise unit 510. For example, selection of the “enterprise unit B” row in the scorecard 500 may result in FIG. 6. As before, the scorecard 600 includes, for various enterprise units 610, health scores 620 for Q2 and a comparison 630 of the Q2 health scores 620 with those from Q1. In this case, the scorecard 600 further includes an interactive popup display 640 detailing the health dimension scores for enterprise unit B in accordance with some embodiments.

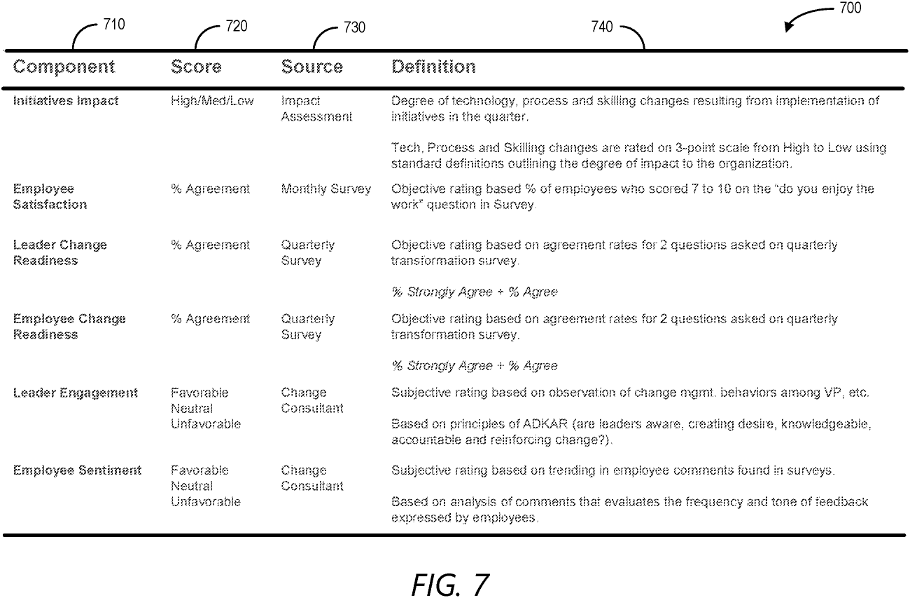

Note that the health dimension scores may be associated with various types of data. FIG. 7 is an example of health dimension score components 700 including a component name 710, a component score type 720 (e.g., high/medium/low or % agreement), a component source 730 (e.g., is the data from a periodic survey, change consultant, etc.), and a component definition 740 (e.g., explaining the method behind calculating the score, the reasons for collecting the information, etc.). Note that the “Employee Sentiment” component is based on an analysis of comments (based on the frequency and tone of feedback). According to some embodiments, this analysis is associated with text mining for employee sentiment via periodic surveys (and may leverage tools available via a data science team to automate the process). That is, themes derived from key words found in employee comments may be automatically summarized and factored into the scoring logic for an enterprise unit.

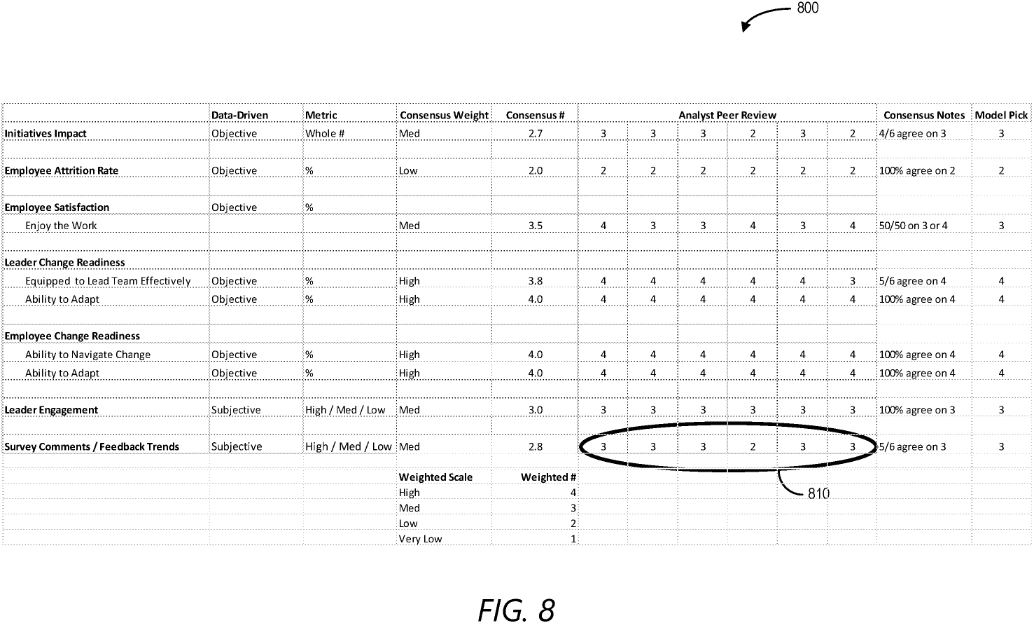

An overall unit health can then be calculated using the health dimension scores and a weighted average model. FIG. 8 is a spreadsheet application 800 to calculate weights in accordance with some embodiments. Note that weights for the weighted average model may be automatically calculated based on a plurality of weight scores. In the example of FIG. 8, each health dimension score is assigned a weight from 1 (very low) through 4 (high). Consider, for example, the set of six analyst peer review weights 810 proposed for the “Survey Comments/Feedback Trends” health dimension score illustrated in FIG. 8 (3, 3, 3, 2, 3, 3). These weights 810 might be proposed by six different managers, consultants, etc. The weights average to “2.8” and five out of the six proposal agreed on “3” being the correct weight. As a result, the model automatically assigns a weight of “3” to the “Survey Comments/Feedback Trends” health dimension score. Note that logic that applies weights to each factor in the model may help ensure that no single element of the scorecard unduly influences or biases the overall score. Moreover, the algorithms design may be based on consultation with data science and performance analytics experts.

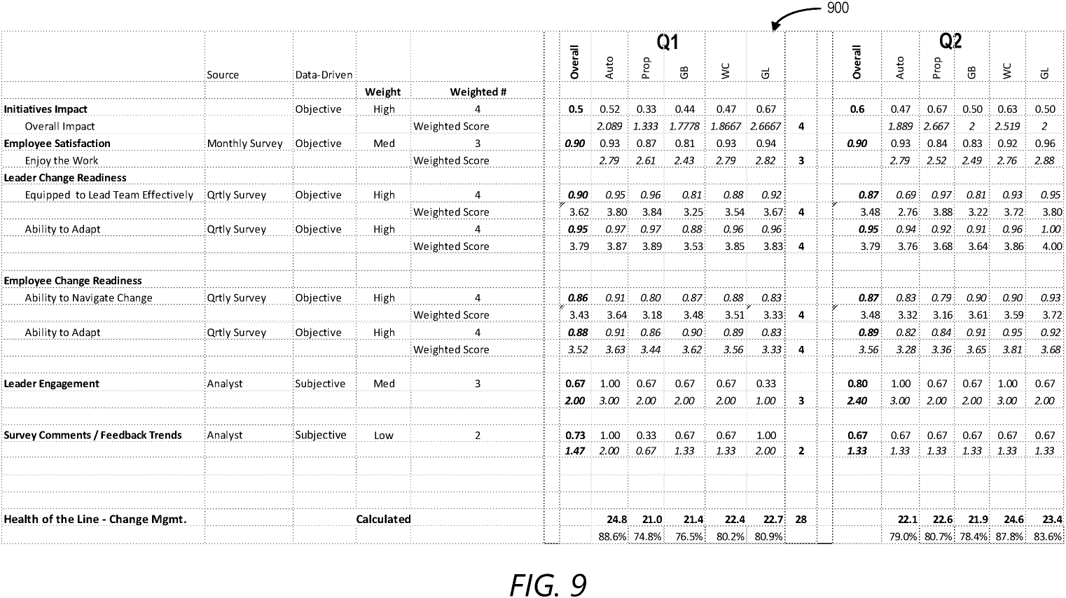

The weights determined by the spreadsheet application 800 of FIG. 8 can then be applied to actual scores to generate a value representing the overall change management health of each business unit. FIG. 9 is a spreadsheet application change management worksheet 900 that automatically performs this task according to some embodiments. In particular, the worksheet 900 includes information for Q1 and Q2 (the same data as is shown in FIGS. 4 and 5). The combination of the distinct elements to derive the score may include objective measures of how change is received and adopted in an organization. The factors might involve, for example, an analysis of organizational impact, employee satisfaction, readiness for change, employee ability to adapt, and leader ability to navigate change.

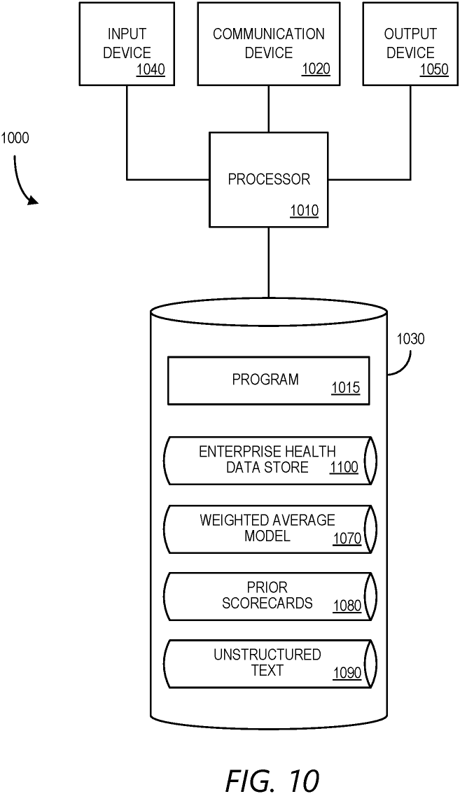

The embodiments described herein may be implemented using any number of different hardware configurations. For example, FIG. 10 illustrates an apparatus 1000 that may be, for example, associated with the system 200 described with respect to FIG. 2. The apparatus 1000 comprises a processor 1010, such as one or more commercially available Central Processing Units (“CPUs”) in the form of one-chip microprocessors, coupled to a communication device 1020 configured to communicate via a communication network (not shown in FIG. 10). The communication device 1020 may be used to communicate, for example, with one or more remote change management devices (e.g., PCs and smartphones), administrator computers, and/or third-party platforms. Note that data exchanged via the communication device 1020 may utilize security features, such as encryption between an insurance company server and change management devices. The security features might be associated with, for example, web servers, firewalls, and/or PCI infrastructure. The apparatus 1000 further includes an input device 1040 (e.g., a mouse and/or keyboard to enter information about business unit, weight scores, survey data, etc.) and an output device 1050 (e.g., to output reports regarding a change management evaluation, summary logs, recommended actions, alerts, etc.).

The processor 1010 also communicates with a storage device 1030. The storage device 1030 may comprise any appropriate information storage device, including combinations of magnetic storage devices (e.g., a hard disk drive), optical storage devices, mobile telephones, and/or semiconductor memory devices. The storage device 1030 stores a program 1015 and/or a change management evaluation tool or application for controlling the processor 1010. The processor 1010 performs instructions of the program 1015, and thereby operates in accordance with any of the embodiments described herein. For example, the processor 1010 may automatically retrieve health dimension scores associated with various enterprise units. A weighted average model may be used by the processor 1010 to automatically calculate an overall unit health score for each enterprise unit based on the associated health dimension scores. A change management scorecard of an interactive graphical change management display is then updated by the processor 1010 and displayed based on the overall unit health scores.

The program 1015 may be stored in a compressed, uncompiled and/or encrypted format. The program 1015 may furthermore include other program elements, such as an operating system, a database management system, and/or device drivers used by the processor 1010 to interface with peripheral devices.

As used herein, information may be “received” by or “transmitted” to, for example: (i) the apparatus 1000 from another device; or (ii) a software application or module within the apparatus 1000 from another software application, module, or any other source.

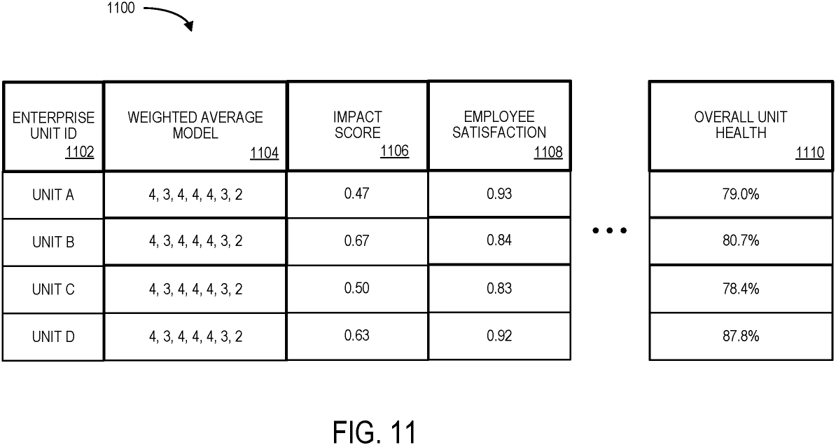

In some embodiments (such as shown in FIG. 10), the storage device 1030 further stores an enterprise health data store 1100 (e.g., associated with quarterly change management evaluations), a weighted average model 1070, prior scorecards 1080, and unstructured text 1090 (e.g., to be mined for employee sentiment). An example of a database that might be used in connection with the apparatus 1000 will now be described in detail with respect to FIG. 11. Note that the database described herein is only an example, and additional and/or different information may be stored therein. Moreover, various databases might be split or combined in accordance with any of the embodiments described herein. For example, the enterprise health data store 1100 and weighted average model 1070 might be combined and/or linked to each other within the program 1015.

Referring to FIG. 11, a table is shown that represents the enterprise health data store 1100 that may be stored at the apparatus 1000 according to some embodiments. The table may include, for example, entries associated with a change management evaluation. The table may also define fields 1102, 1104, 1106, 1108, 1110 for each of the entries. The fields 1102, 1104, 1106, 1108, 1110 may, according to some embodiments, specify: an enterprise unit identifier 1102, a weighted average model 1104, an impact score 1106, employee satisfaction 1108, and an overall unit health 1110. The enterprise health data store 1100 may be created and updated, for example, based on information electrically received from various data sources (e.g., including when an enterprise unit is added or removed, a new periodic evaluation is performed, etc.).

The enterprise unit identifier 1102 may be, for example, a unique alphanumeric code identifying a business unit to be evaluated. The weighted average model 1104 may comprise a series of weights to be applied to various health dimension scores. The health dimension scores may include, for example, the impact score 1106, employee satisfaction 1108, etc. The overall unit health 1110 may comprise the result of applying the weighted average model 1104 to the health dimension scores for each enterprise unit identifier 1102 (and may be presented on a change management evaluation scorecard).

Thus, embodiments may provide an automated and efficient way to perform a change management evaluation. The change management scorecard may use a fact-based approach to assess the readiness for change using factors such as leader engagement, employee adaptability, etc. The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of enterprises (e.g., an insurance company), embodiments may instead be associated with other types of enterprises in addition to and/or instead of those described herein (e.g., financial institutions, hospitals, etc.). Similarly, although certain types of change management health dimensions were described in connection some embodiments herein, other types of dimensions might be used instead of, or in addition to, those mentioned.

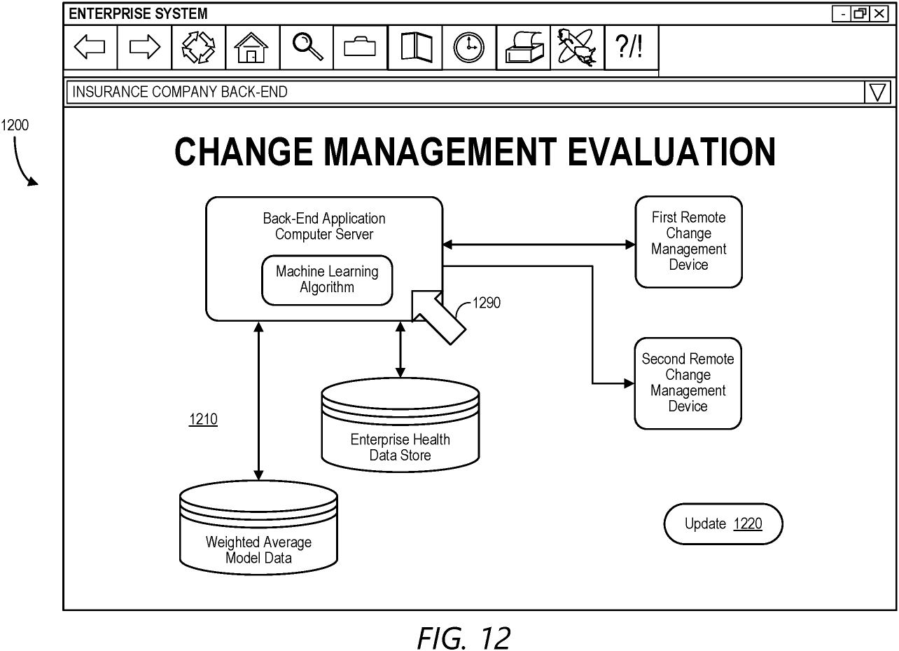

Note that the displays and devices illustrated herein are only provided as examples, and embodiments may be associated with any other types of interfaces. For example, FIG. 12 is a change management administrator display 1200 including graphical representations of elements 1210 of a change management evaluation system. Selection of a portion or element of the display 1200 might result in the presentation of additional information about that portion or device (e.g., a popup window presenting a more detailed view of weights, scores, data sources, or other specifics of the system implementation) or let an operator or administrator enter or annotate additional information about the change management evaluation system (e.g., based on his or her experience and expertise). Selection of an “Update” icon 1220 (e.g., by touchscreen or computer mouse pointer 1290) might cause the system or platform to save changes, transmit a scorecard to another party, etc. According to some embodiments a scorecard or alert may be automatically transmitted to a communication device (e.g., associated with a manager or leader of a business unit) when a score moves beyond a threshold value.

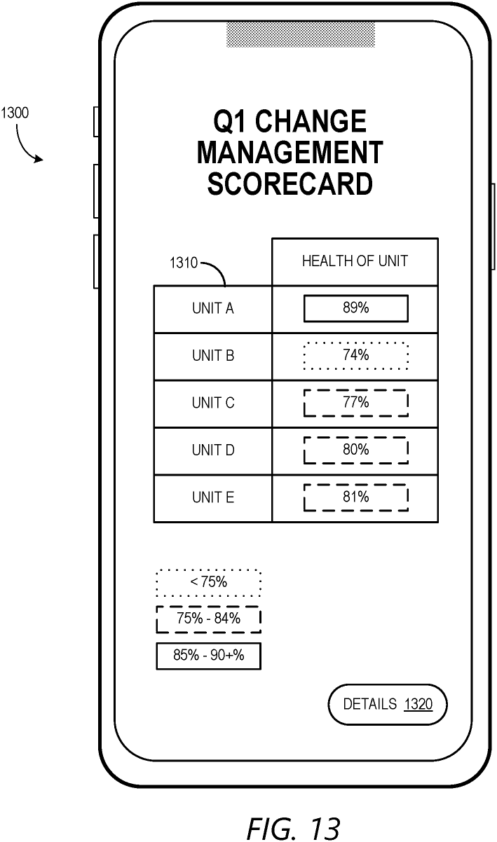

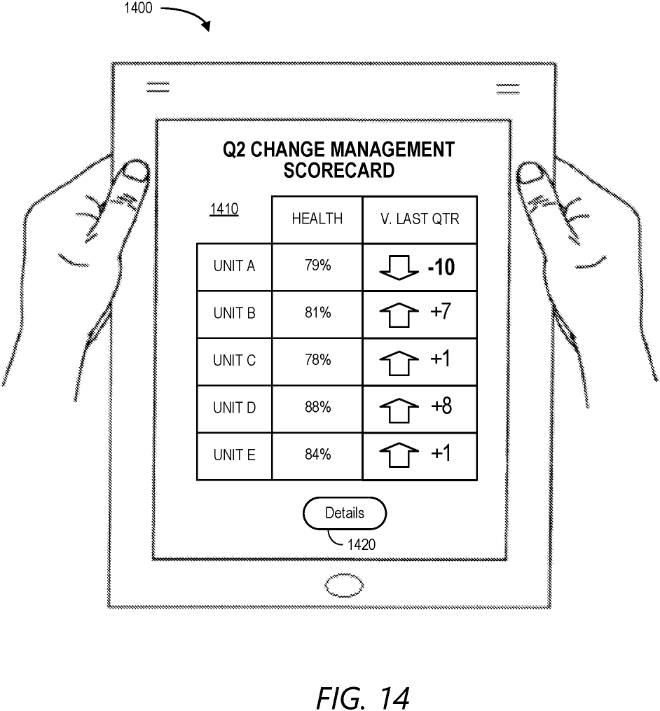

FIG. 13 illustrates a smartphone display 1300 according to some embodiments. The display 1300 includes a scorecard 1310 similar to the one described in connection with FIG. 4. Selection of a “Details” icon 1320 might result in the display of underlying health dimension scores for a business unit. Similarly, FIG. 14 illustrates a handheld tablet display in accordance with some embodiments. The display 1400 includes a scorecard 1410 similar to the one described in connection with FIG. 5. Selection of a “Details” icon 1420 might result in the display of underlying health dimension scores for a business unit.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A change management evaluation system implemented via a back-end application computer server, comprising:
(a) an enterprise health data store that contains electronic records associated with a set of enterprise units, each electronic record including an electronic record identifier and plurality of health dimension scores associated with an enterprise’s ability to implement changes, wherein at least one health dimension score is based at least in part on a sentiment score automatically generated by a machine learning algorithm analysis of unstructured text data;
(b) the back-end application computer server, coupled to the enterprise health data store, including:
a computer processor, and
a computer memory, coupled to the computer processor, storing instructions that, when executed by the computer processor cause the back-end application computer server to:
(i) automatically retrieve, from the enterprise health data store, the health dimension scores associated with each enterprise unit,
(ii) for each enterprise unit, use a weighted average model to automatically calculate an overall unit health score for each enterprise unit based on the associated health dimension scores, and
(iii) update a change management scorecard of an interactive graphical change management display based on the calculated overall unit health scores; and
(c) a communication port coupled to the back-end application computer server to facilitate an exchange of data with a remote change management device to support the interactive graphical change management display, including the updated change management scorecard, via a distributed communication network.

2. The system of claim 1, wherein the health dimension scores include at least one of: (i) subjective scores, (ii) objective scores, (iii) qualitative scores, and (iv) quantitative scores.

3. The system of claim 2, wherein at least one health dimension score is associated with: (i) a numerical rating, (ii) a category, (iii) a percentage, (iv) a periodic survey, and (v) a change consultant analysis.

4. The system of claim 3, wherein the health dimension scores comprise: (i) initiatives impact, (ii) employee satisfaction, (iii) leader change readiness, (iv) employee change readiness, (v) leader engagement, and (vi) employee sentiment.

5. The system of claim 1, wherein selection of an enterprise unit on the change management scorecard results in the display of the associated health dimension scores for that enterprise unit on the interactive graphical change management display.

6. The system of claim 1, wherein weights for the weighted average model are automatically calculated based on a plurality of weight scores.

7. The system of claim 1, wherein an overall enterprise health score is calculated based on the overall unit health score for each enterprise unit.

8. The system of claim 1, wherein the change management scorecard includes current overall unit health scores and information about prior overall unit health scores to highlight and understand trending over time.

9. The system of claim 1, wherein the enterprise comprises an insurance company and the enterprise units are associated with insurance lines of business.

10. The system of claim 9, wherein the insurance lines of business include: (i) automobile, (ii) property, (iii) group benefits, (iv) workers’ compensation, and (v) general liability.

11. A computerized change management evaluation method implemented via a back-end application computer server, comprising:
automatically retrieving, by a computer processor of the back-end application computer server from an enterprise health data store, health dimension scores associated with each of a set of enterprise units, wherein the enterprise health data store contains electronic records associated with the set of enterprise units, each electronic record including an electronic record identifier and plurality of health dimension scores associated with an enterprise’s ability to implement changes, wherein at least one health dimension score is based at least in part on a sentiment score automatically generated by a machine learning algorithm analysis of unstructured text data;
for each enterprise unit, using a weighted average model to automatically calculate an overall unit health score for each enterprise unit based on the associated health dimension scores; and
updating a change management scorecard of an interactive graphical change management display based on the calculated overall unit health scores,
wherein a communication port coupled to the back-end application computer server facilitates an exchange of data with a remote change management device to support the interactive graphical change management display, including the updated change management scorecard, via a distributed communication network.

12. The method of claim 11, wherein the health dimension scores include at least one of: (i) subjective scores, (ii) objective scores, (iii) qualitative scores, and (iv) quantitative scores.

13. The method of claim 12, wherein at least one health dimension score is associated with: (i) a numerical rating, (ii) a category, (iii) a percentage, (iv) a periodic survey, and (v) a change consultant analysis.

14. The method of claim 13, wherein the health dimension scores comprise: (i) initiatives impact, (ii) employee satisfaction, (iii) leader change readiness, (iv) employee change readiness, (v) leader engagement, and (vi) employee sentiment.

15. The method of claim 11, wherein selection of an enterprise unit on the change management scorecard results in the display of the associated health dimension scores for that enterprise unit on the interactive graphical change management display.

16. The method of claim 11, wherein weights for the weighted average model are automatically calculated based on a plurality of weight scores.

17. The method of claim 11, wherein an overall enterprise health score is calculated based on the overall unit health score for each enterprise unit.

18. A non-transitory, computer-readable medium storing instructions, that, when executed by a processor, cause the processor to perform a change management evaluation method implemented via a back-end application computer server, the method comprising:
automatically retrieving, by a computer processor of the back-end application computer server from an enterprise health data store, health dimension scores associated with each of a set of enterprise units, wherein the enterprise health data store contains electronic records associated with the set of enterprise units, each electronic record including an electronic record identifier and plurality of health dimension scores associated with an enterprise’s ability to implement changes, wherein at least one health dimension score is based at least in part on a sentiment score automatically generated by a machine learning algorithm analysis of unstructured text data;
for each enterprise unit, using a weighted average model to automatically calculate an overall unit health score for each enterprise unit based on the associated health dimension scores; and
updating a change management scorecard of an interactive graphical change management display based on the calculated overall unit health scores,
wherein a communication port coupled to the back-end application computer server facilitates an exchange of data with a remote change management device to support the interactive graphical change management display, including the updated change management scorecard, via a distributed communication network.

19. The medium of claim 18, wherein the change management scorecard includes current overall unit health scores and information about prior overall unit health scores to highlight and understand trending over time.

20. The medium of claim 18, wherein the enterprise comprises an insurance company and the enterprise units are associated with insurance lines of business.

21. The medium of claim 20, wherein the insurance lines of business include: (i) automobile, (ii) property, (iii) group benefits, (iv) workers’ compensation, and (v) general liability.
